(19) United States
(12) Patent Application Publication
(10) Pub. No.: US 2011/0025160 A1
(43) Pub. Date: Feb. 3, 2011

(54) RECTANGULAR CROSS-SECTION WINDINGS FOR ELECTRICAL MACHINE ROTORS

(75) Inventors: CONSTANTIN C. STANCU, ANAHEIM, CA (US); PETER J. SAVAGIAN, BLOOMFIELD HILLS, MI (US); ERIK HATCH, CYPRESS, CA (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/534,408

(22) Filed: Aug. 3, 2009

(51) Int. Cl. H02K 3/48

(52) U.S. Cl. 310/180; 310/216.069

(57) ABSTRACT

An apparatus is provided for an electrical machine rotor. The apparatus comprises a cylinder and a first slot proximate to an edge of the cylinder. The first slot is at least partially closed. The apparatus further comprises a hairpin winding disposed within the first slot.

### TECHNICAL FIELD

This disclosure relates generally to electrical machines, and more particularly, the disclosure relates to Alternating Current (AC) machine rotors that have windings with rectangular cross-sections.

### BACKGROUND OF THE INVENTION

In hybrid electric and electric vehicles, high speed synchronous electrical machines are used for traction. In some instances, permanent magnets are used for achieving the excitation field of the rotor. In other instances, where motor cost or a higher rotor flux density is a concern, wound rotors are used.

A wound rotor of a synchronous AC machine includes a direct-current (DC) winding on the rotor. This DC winding is referred to as an excitation winding. When supplied with DC current, the excitation winding creates a stationary magnetic field on the rotor periphery that interacts with the stator magnetic field of the machine in order to generate mechanical torque in the process of electromechanical power conversion.

There are two distinct types of rotor configurations for wound rotor synchronous machines, which are illustrated in FIGS. 1 and 2. FIG. 1 is a diagram that is illustrative of a salient pole rotor. FIG. 2 is a diagram that is illustrative of a non-salient or cylindrical rotor.

Referring to FIG. 1, the salient pole rotor 100 rotates on a rotor shaft 110 within a stator 130. A concentrated winding 120 is wound around each pole of the rotor 100. Each pole of the rotor 100 is fabricated separately and mechanically attached to the rotor shaft 110. Because of this construction, the mass of the concentrated winding 120 combined with the mass of the poles of the rotor 100 subject the rotor to high centrifugal forces at higher rotor speeds. For this reason, non-salient or cylindrical rotor configurations are generally used for hybrid electric and electrical vehicles because their motors are typically operated at high speed.

Referring to FIG. 2, the cylindrical rotor 200 rotates on a rotor shaft 210 within a stator 230. Rotor slots 220 are present on the outside of the rotor 200 and provide a place for the excitation windings (not shown).

FIG. 3 is a diagram that illustrates a conventional method of assembling an excitation winding on a cylindrical rotor, such as the cylindrical rotor of FIG. 2. FIG. 3 illustrates a portion of a cylindrical rotor 300 including a number of rotor slots 310. A pre-fabricated winding element 320 is positioned in the appropriate rotor slots 310 by placing the element over the rotor slots and then moving the element downwards, towards the center of the cylindrical rotor. Once the pre-fabricated winding element 320 is positioned in the rotor slots 310, it is secured using metal wedges (not shown) that are positioned across the slot openings.

Some of the disadvantages of fabricating a wound rotor in the manner described above are that the pre-fabricated winding elements 320 are obtained using a labor-intensive process, and also that the requirement to close the rotor slots 310 using metal wedges increases the expense of the rotor.

Accordingly, it is desirable to have a rotor that does not require pre-fabricated winding elements 320. In addition, it is desirable to have a rotor that does not require metal wedges to close the rotor slots. Other desirable features and characteristics of the present invention will become apparent from the subsequent detailed description and the appended claims, taken in conjunction with the accompanying drawings and the foregoing technical field and background.

### SUMMARY

According to various embodiments, an apparatus is provided for an electrical machine rotor. The apparatus comprises a cylinder and a first slot proximate to an edge of the cylinder. The first slot is at least partially closed. The apparatus further comprises a hairpin winding disposed within the first slot.

According to other embodiments, a method for fabricating a rotor for an electrical machine is provided. The method comprises fabricating a first slot and a second slot proximate to an edge of a rotor. The first and second slots are at least partially closed. The method further comprises inserting a first end of a first hairpin winding into a first end of the first slot, and inserting a second end of the first hairpin winding into a first end of the second slot. The first end of the first slot and the first end of the second slot are disposed at an end of the rotor. The method further comprises advancing the first and second ends of the first hairpin winding in a same direction through the first and second slots, respectively, such that the first and second ends of the first hairpin winding exit the first and second slots from a second end of the first slot and a second end of the second slot. The second end of the first slot and the second end of the second slot are disposed at another end of the rotor.

### BRIEF DESCRIPTION OF THE DRAWINGS

The present invention will hereinafter be described in conjunction with the following drawing figures, wherein like numerals denote like elements, and

FIG. 1 is a diagram that is illustrative of a conventional salient pole rotor;

FIG. 2 is a diagram that is illustrative of a conventional non-salient or cylindrical rotor;

FIG. 3 is a diagram that illustrates a conventional method of assembling an excitation winding on a cylindrical rotor, such as the cylindrical rotor of FIG. 2;

FIG. 4 is a diagram that illustrates a hairpin winding element suitable for use with example embodiments;

FIG. 5 is a diagram that illustrates the shape of the hairpin winding element of FIG. 4 after being inserted into a pair of rotor slots;

FIG. 6 is a diagram that illustrates a segment of a rotor having closed rotor slots that is suitable for use with example embodiments;

FIG. 7 is a diagram that illustrates a segment of a rotor having semi-closed rotor slots that is suitable for use with example embodiments;

FIG. 8 is a sectional diagram illustrating some components of an electrical machine, the electrical machine including a cylindrical rotor having an 8-pole excitation winding in accordance with an example embodiment;

FIG. 9 is a winding diagram that further illustrates the 8-pole excitation winding of FIG. 8;

FIG. 10 is another winding diagram that further illustrates the 8-pole excitation winding of FIG. 8; and

FIG. 11 is a flow diagram illustrating some processes included in a method of fabricating a rotor for an electrical machine in accordance with an example embodiment.

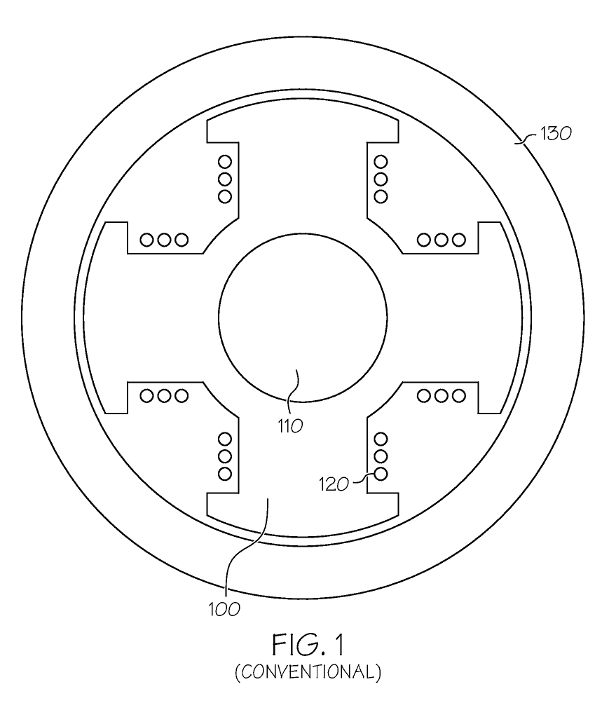

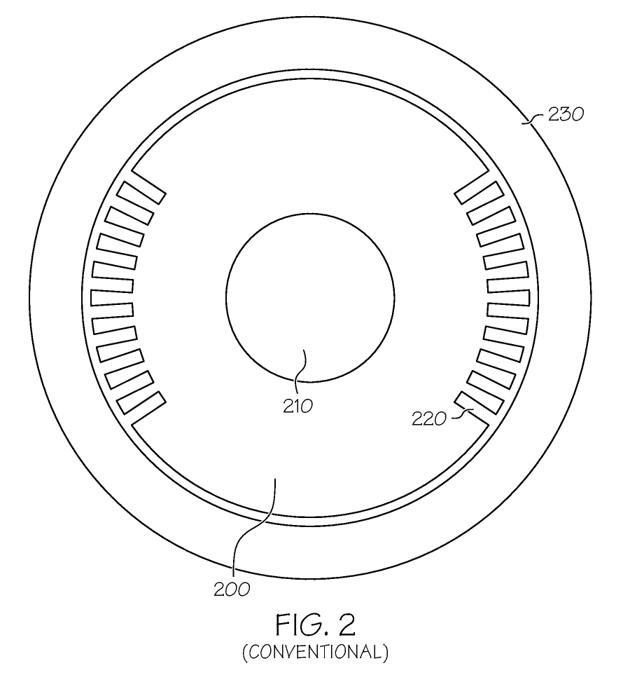

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary, or the following detailed description.

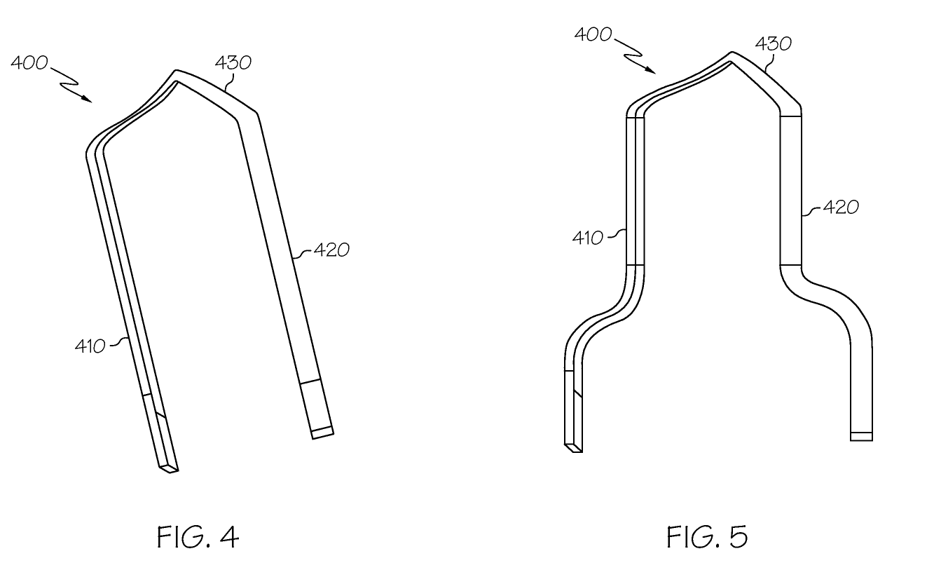

FIG. 4 is a diagram that illustrates a hairpin winding element 400 that is suitable for use with example embodiments. FIG. 5 is a diagram that illustrates the shape of the hairpin winding element 400 of FIG. 4 after the winding element is inserted into a pair of rotor slots and subsequently bent to in order to be joined to other hairpin winding elements in other rotor slots in accordance with example embodiments.

Referring to FIGS. 4 and 5, the hairpin winding element 400 includes a first leg 410, a second leg 420, and an endturn 430 that joins the first leg to the second leg. The hairpin winding element 400 may be formed of a rectangular bar of one or more conductive metals. The hairpin winding element 400 may be formed, for example, of a rectangular copper bar that has been bent into the shape that is illustrated in FIG. 4. According to alternative embodiment, the length and shape of the endturn 430 may be adjusted in order to increase or decrease the separation between the first leg 410 and the second leg 420. In this manner, a hairpin winding element may be obtained that is designed to fit in virtually any pair of rotor slots.

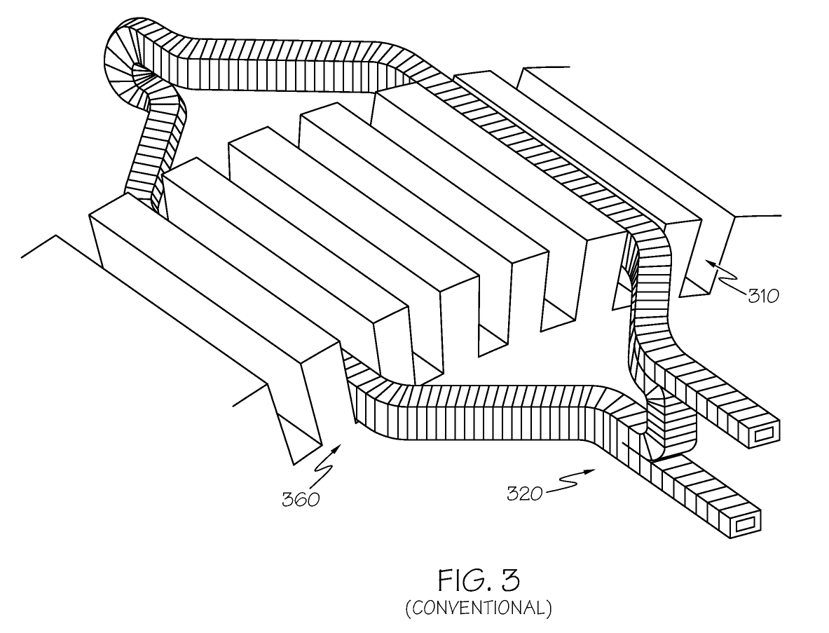

Unlike the pre-fabricated winding element 320 illustrated in FIG. 3, the shape of the hairpin winding element 400 of FIG. 4 allows the hairpin winding element to be positioned within a closed or semi-closed rotor slots by simultaneously inserting an end of the first leg 410 into an end of a first predetermined rotor slot and an end of the second leg 420 into an end of a second predetermined rotor slot. Next, the first leg 410 and the second leg 420 of the hairpin winding element 400 may be advanced simultaneously along the length of the predetermined rotor slots until the ends of the first leg and the second leg protrude from the opposite ends of the predetermined rotor slots. After the hairpin winding element 400 is inserted through the predetermined rotor slots, the ends of the first leg 410 and the second leg 420 may be bent into a predetermined shape, such as the shape shown in FIG. 5, in order that the ends of the first leg and second leg can be connected to the ends of other legs of other hairpin winding elements, forming a completed winding set. This operation is usually done automatically, by a machine.

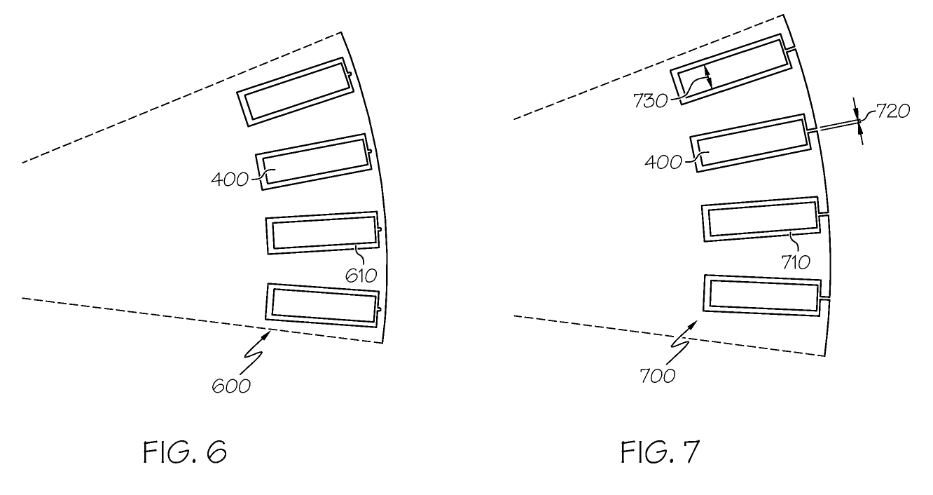

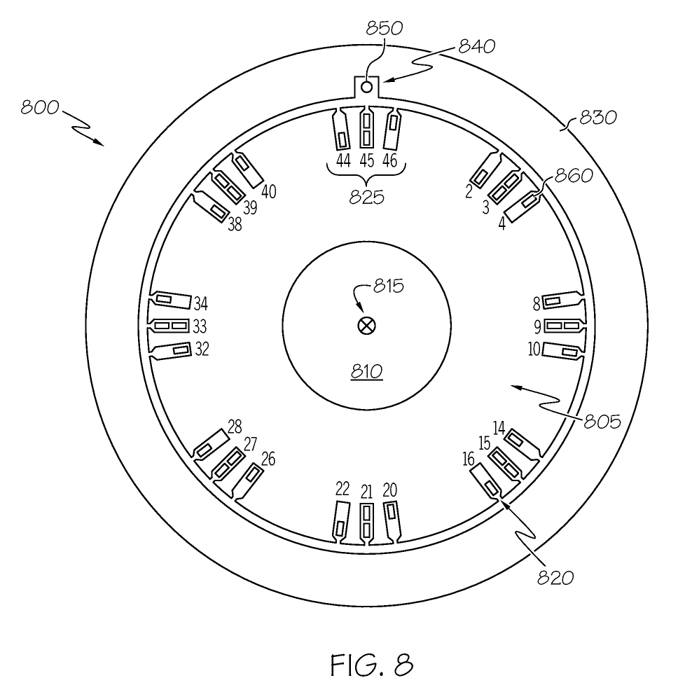

FIG. 6 is a sectional diagram that illustrates a segment of a cylindrical rotor having closed rotor slots that is suitable for use with example embodiments, while FIG. 7 is a sectional diagram that illustrates a segment of a cylindrical rotor having semi-closed rotor slots that is suitable for use with example embodiments.

The closed rotor slots 610 of the cylindrical rotor segment 600 are described as closed because the rotor slots do not have openings on the curved outer surface of the cylindrical rotor segment. The semi-closed rotor slots 710 of the cylindrical rotor segment 700 are described as semi-closed because while the rotor slots do have openings on the curved outer surface of the cylindrical rotor segment, a width 720 of the openings is less than a width 730 of the hairpin winding element 400.

A hairpin winding element 400 is shown inserted into each one of the rotor slots 610 or 710, and the rectangular cross-section of the hairpin winding element can be seen. Because of the closed and semi-closed slots, the hairpin winding elements 400 are positioned within the rotor slots 610 and 710 by inserting ends of the first and second legs 410, 420 of the hairpin winding elements into one end of the rotor slots, and then advancing the hairpin winding elements down the length of the rotor slots until the first and second legs protrude from the other end of the rotor slots. The length of the rotor slots 610, 710 is in a direction perpendicular to the plane in which FIG. 6 and FIG. 7 are displayed.

The shape of the closed rotor slots 610 and the shape of the semi-closed rotor slots 710 prevent the hairpin winding elements 400 from being ejected from the rotor slots due to centrifugal force when the rotor is operational. Thus, the use of the hairpin winding elements 400 in conjunction with closed rotor slots 610 or semi-closed rotor slots 710 as illustrated in FIGS. 6 and 7 eliminates the conventional technique of using slot wedges to close an open rotor slot, such as the open rotor slot 310 of FIG. 3, in order to hold the pre-fabricated winding element 320 in place within the open rotor slot 310. The open rotor slot 310 of FIG. 3 is referred to as open because a width of the opening of the rotor slot 310 is greater than a width of the pre-fabricated winding element 320 that is disposed within the rotor slot. It should be apparent that closing the open rotor slots 310 is needed to prevent the pre-fabricated winding element 320 from being ejected from the open rotor slots due to centrifugal force when the rotor is operational.

After the hairpin winding element 400 has been inserted into the appropriate rotor slot, the ends of the hairpin winding element are bent so that they are proximate to the ends of other hairpin winding elements that occupy other rotor slots. FIG. 5 illustrates how the ends of the first leg 410 and the second leg 420 might look after being bent. Thereafter, the ends of the hairpin winding elements 400 may be welded together in order to assemble the desired winding or windings in the desired configuration inside the rotor slots. For further details regarding an exemplary method for joining the ends of hairpin winding elements, one may refer to U.S. Pat. No. 7,034,428 to Cai et al., which discloses an assembly of stator windings using hairpin winding elements.

FIG. 8 is a sectional diagram illustrating some components of an electrical machine 800. The electrical machine 800 includes a cylindrical rotor 805, a shaft 810 attached to the cylindrical rotor 805, and a stator 830 disposed around the rotor and shaft. During operation of the electrical machine 800, the shaft 810 and rotor 805 spin about a rotational axis 815 passing longitudinally through a center of the shaft. The stator 830 includes a stator slot 840 and a stator winding 850 housed inside the stator slot.

The cylindrical rotor 805 includes twenty four rotor slots 820. The rotor slots 820 are arranged in slot groupings 825 around the outside edge of the cylindrical rotor 805, each slot grouping having three rotor slots. To differentiate between individual rotor slots 820, the rotor slots are assigned numbered positions along the edge of the cylindrical rotor, with the rotor slots 820 in each slot grouping assigned consecutively numbered positions. Thus, the rotor slots 820 in positions 2, 3, and 4 constitute a slot grouping 825, the rotor slots 820 in positions 8, 9, and 10 constitute a slot grouping, etc. Each of the eight slot groupings 825 corresponds to one of the eight poles in the DC excitation winding.

The central rotor slots 820 in each slot grouping 825 are arranged approximately 45 degrees apart from one another. That is, the rotor slot 820 in position 3 is offset approximately 45 degrees from the rotor slots in positions 45 and 9, the rotor slot in position 15 is offset approximately 45 degrees from the rotor slots in position 9 and 21, etc.

According to the example embodiment, the angular spacing between each slot grouping 825 is approximately the same as the angular spacing across each slot grouping. For example, assuming that the rotor slots 820 have a substantially uniform size and that the angular spacing between the adjacent rotor slots in each slot grouping 825 is substantially uniform, there is space for three additional rotor slots between the rotor slot in position 4 and the rotor slot in position 8. Likewise, three more rotor slots 820 could be disposed between the rotor slot in position 10 and the rotor slot in position 14. Following this pattern around the circumference of the cylindrical rotor 805, it is apparent that for every position on the cylindrical rotor that is occupied by a rotor slot 820, there is another position that is unoccupied by a rotor slot. Thus, the cylindrical rotor 805 may be described as having forty-eight positions, with twenty-four rotor slots 820 occupying half of those positions.

The angular spacing between each rotor slot 820 in a slot grouping 825 is easily calculated by dividing the number of degrees in a circle by the number of positions on the cylindrical rotor 805. In this case, the angular spacing between the rotor slots 820 in a slot grouping 825 is 7.5 degrees (360/48=7.5).

Of course, the electrical machine 800 that is illustrated in FIG. 8 is merely an example. The arrangement of the rotor slots 820 of the cylindrical rotor 805 is typically a design choice, and other example embodiments may have rotors with rotor slots that are arranged in configurations that are different from the configuration shown in FIG. 8.

In the electrical machine 800, the rotor slots 820 of the cylindrical rotor 805 are partially closed, like the rotor slots 710 of FIG. 7. In other words, a width across the opening of the rotor slot 820 is narrower than a width across the rest of the rotor slot.

According to alternative embodiments, the rotor slots may be fully closed, like the rotor slots 610 of FIG. 6. That is, the rotor slots 820 may be enclosed by the cylindrical rotor 805 in directions perpendicular to the rotational axis 815.

The electrical machine 800 further includes legs 860 of hairpin winding elements that are disposed within each of the rotor slots 820. As will be explained in further detail below, each leg 860 of a hairpin winding element is disposed in one of the rotor slots 820. Equivalently, one hairpin winding element is disposed in two of the rotor slots 820. The legs 860 of the hairpin winding elements are interconnected to form two independent windings.

As illustrated in FIG. 8, the rotor slots 820 that occupy the central position in each of the slot groupings 825 contain two legs 860 of the hairpin winding elements, with one leg arranged over the other leg in a two layer configuration. In the other rotor slots 820 in the slot groupings 825, there is only one leg 860 of a hairpin winding element, and these legs are arranged either at the lower level or the upper level of the two layer configuration.

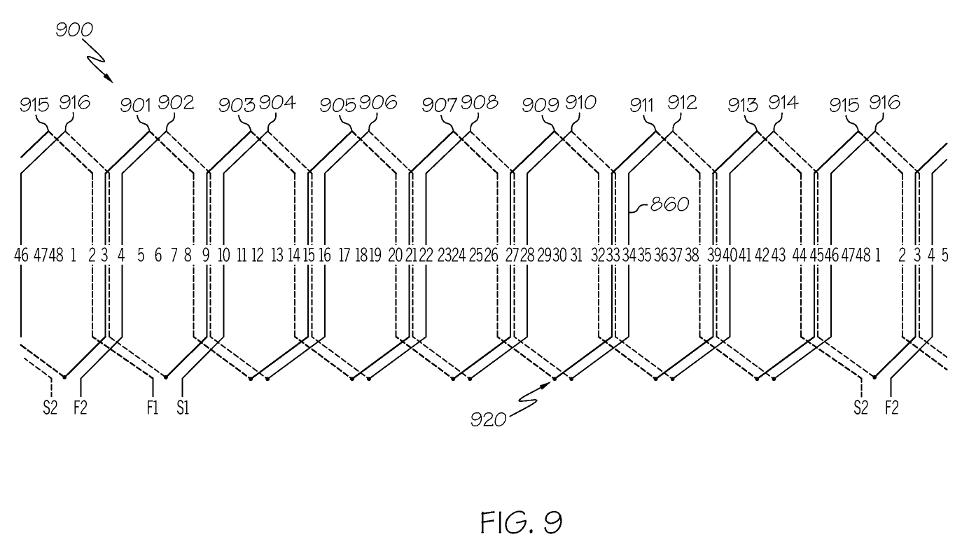

FIG. 9 is a winding diagram 900 that further illustrates the 8-pole excitation winding for the cylindrical rotor 805 of FIG. 8. In diagram 900, all forty-eight positions of the cylindrical rotor 805 are indicated. As was explained above, only twenty-four rotor slots 820 are present on the cylindrical rotor 805, occupying the positions that are shown in FIG. 8 and FIG. 9.

Two independent windings are illustrated in FIG. 9, with S1 and F1 indicating the start and finish, respectively, of the first winding. Likewise, S2 and F2 indicate the start and finish, respectively, of the second winding. Each of the windings is illustrated using a continuous line that is both solid and dashed. The solid portion of the line indicates that the corresponding portion of the winding occupies the upper layer in the two-layer configuration of FIG. 8, while the dashed portion of the line indicates that the corresponding portion of the winding occupies the lower layer.

The first and second windings are formed from a plurality of hairpin winding elements 901-916. Each of the hairpin winding elements 901-916 include two legs 860, which run lengthwise through the rotor slots 820 as illustrated in FIG. 8. The endturns of the hairpin winding elements 901-916 are displayed at the top of diagram 900, while the connections 920 between the leg 860 of one hairpin winding element and the leg 860 of another hairpin winding element are displayed at the bottom of diagram 900. Therefore, the top of diagram 900 corresponds to one end of the cylindrical rotor 805 of FIG. 8, while the bottom of diagram 900 corresponds to the other end of the cylindrical rotor.

Diagram 900 illustrates the 48 positions of the cylindrical rotors 805 of FIG. 8, as well as how the hairpin winding elements 901-916 are arranged relative to those positions. Of course, although FIG. 9 refers to the positions on the cylindrical rotor 805 where the rotors slots 820 are located, the hairpin winding elements 901-916 are in actuality physically disposed within the rotor slots 820 as illustrated in FIG. 8. For example, FIG. 8 illustrates that the rotor slot 820 at position 3 accommodates two legs 860 of the hairpin winding elements. This information is also reflected in FIG. 9, where the legs 860 of two winding elements 901 and 916 are shown disposed at position 3. In FIG. 9, positions that are not associated with one or more of the hairpin winding elements 901-916 do not correspond to one of the rotor slots 820 of FIG. 8.

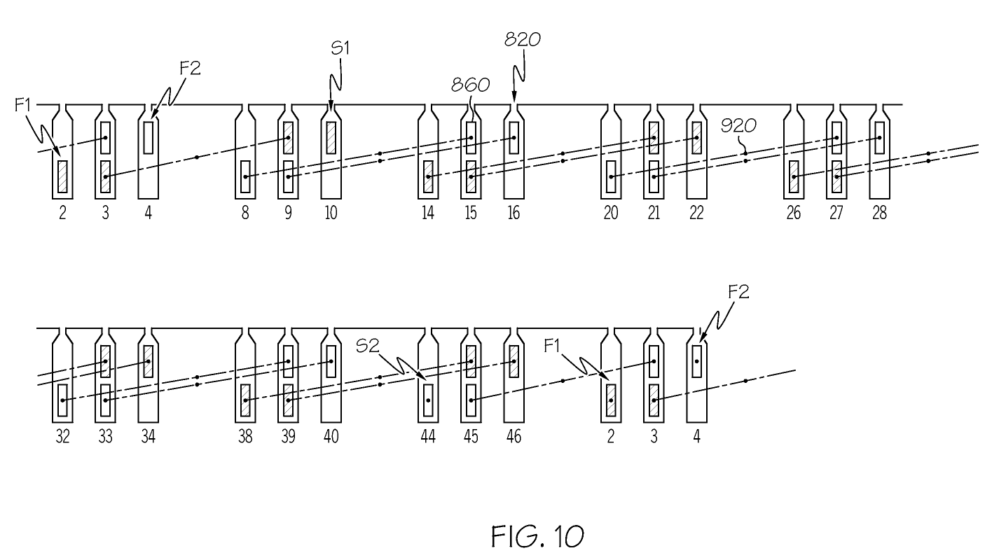

FIG. 10 is another winding diagram that further illustrates the 8-pole excitation winding of the cylindrical rotor 805 of FIG. 8. FIG. 10 illustrates each of the rotor slots 820 of FIG. 8, as well as its corresponding position on the cylindrical rotor 805.

FIG. 10 is also illustrative of the connections 920 between the legs 860 of the hairpin winding elements 901-916 of FIG. 9. That is, FIG. 10 is taken from the perspective of looking at the end of the cylindrical rotor 805 where the legs 860 are bent to form connections with a leg 860 from another hairpin winding element. Although the connections 920 between the legs 860 of the hairpin winding elements are illustrated with dotted lines, this is done to avoid unnecessarily obscuring aspects of the example embodiment. As shown in FIGS. 4 and 5, hairpin winding elements usually have a substantially uniform cross-section along their length. During fabrication, after the hairpin winding elements 901-916 have been inserted through the rotor slots 820 from end of the cylindrical rotor and out the other end of the cylindrical rotor, the portion of the legs 860 that extend from the rotor slots 820 may be bent such that the end of one leg 860 meets the end of another leg of another winding element. Next, the junction between the two legs may be welded to form the connection 920 between the two legs 860.

In FIG. 10, the legs 860 that are part of hairpin winding elements belonging to the first winding are cross-hatched, while the legs 860 that are part of hairpin winding elements belonging to the second winding are clear. Like FIG. 9, FIG. 10 also illustrates the start S1 and finish of the first winding as well as the start S2 and finish F2 of the second winding. In order to achieve the required number of turns, the two windings can be connected either in parallel (S1 connected to S2, F1 connected to F2) or in series (F1 connected to S2). Of course, although only two windings (S1-F1, S2-F2) are illustrated in FIGS. 8-10, more than two rotor windings can be fabricated using the hairpin winding elements, depending on the depth of the rotor slot 820 and the corresponding dimension of the hairpin winding element.

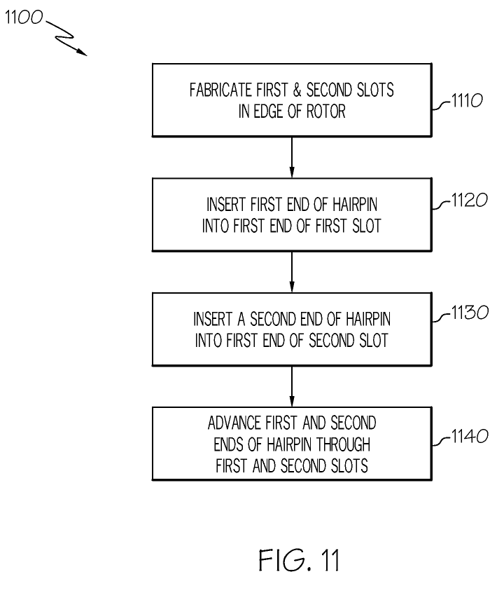

FIG. 11 is a flow diagram illustrating some processes included in a method 1100 of fabricating a rotor for an electrical machine in accordance with an example embodiment. In a first process 1110, a first and a second rotor slot are fabricated proximate to the edge of a cylindrical rotor. The rotor slots may be semi-closed like the rotor slots 710 of FIG. 7. Alternatively, the rotor slots may be closed like the rotor slots 610 of FIG. 6. According to some embodiments, fabricating the first and second rotor slot may include assembling a plurality of cylindrical rotor laminations that have first and second openings provided in the lamination. The flat surfaces of the cylindrical rotor laminations may be aligned and attached such that the first openings form the first rotor slot through the cylindrical rotor and the second openings form the second rotor slot through the cylindrical rotor.

Next, in process 1120, the first end of a hairpin winding element is inserted into a first end of the first rotor slot. Thereafter, in process 1130, the second end of the hairpin winding element is inserted in a first end of the second rotor slot. According to example embodiments, the first end of the first rotor slot and the second end of the second rotor slot are both disposed at one end of the cylindrical rotor.

In process 1140, the first and second ends of the hairpin winding element are advanced through the first and the second rotor slots, in a direction that is parallel to the length of the first and the second rotor slots. Once the first and second ends of the hairpin winding element have been advanced to the point that they are extruded from the second end of the first rotor slot and the second end of the second rotor slot, they extruded portions of the first and second ends may be bent in a predetermined fashion to meet the ends of other hairpin winding elements. The junctions between the ends of the winding elements may then be welded to form one or more independent rotor windings.

According to other example embodiments, the order in which the processes 1110-1140 are performed may be rearranged. For example, a first end of a hairpin winding element may be inserted in a first end of a first rotor slot and then advanced through the first rotor slot prior to the second end of the hairpin winding element being inserted into a first end of a second rotor slot. In this case, the hairpin winding element may be shaped as a straight piece of rectangular metal prior to insertion into the first rotor slot. After advancement through the first rotor slot, the hairpin winding element may be bent such that second end of the hairpin winding element is inserted and then advanced through the second rotor slot.

According to other example embodiments, there may be more or fewer processes included than those illustrated in FIG. 11. For example, some embodiments may not include process 1110 where first and second slots are fabricated in the edge of the cylindrical rotor.

There are many benefits and advantages that may be gained from example embodiments, some of which are described below. For instance, example embodiments provide a low cost alternative to permanent magnet based rotors for synchronous electrical machines. Furthermore, machine airgap flux densities are likely to be increased by using wound rotors, since excitation flux is generated by controllable ampere-turns rather than fixed permanent magnet flux.

According to example embodiments, pre-fabricated, labor-intensive windings, such as the winding 320 of FIG. 3 may be eliminated. The entire forming, bending, and insertion of hairpin winding elements to form rotor windings are completely automated operations that utilize specialized manufacturing equipment, which may reduce cost.

According to example embodiments, since the hairpin winding elements are paired with closed or semi-closed rotor slots, there is no need to use metallic slot wedges to secure the rotor windings against centrifugal forces at high rotor speeds. Example embodiments may also achieve a high copper-to-slot area fill factor which improves machine efficiency. Example embodiments are also compatible with direct oil cooling methods, which are frequently encountered in hybrid electric vehicle applications. The spaces between the end-turns of the hairpin winding elements are accessible to oil flow for efficient heat removal.

According to some embodiments, particularly those that implement a DC-excitation winding on a rotor, conductor transposition to minimize skin-effect is not required. Skin effect refers to the non-uniform distribution of AC current at the surface of the hairpin winding elements. The concept of rotor hairpin windings is not limited to DC windings, however. Example embodiments may also include rotor windings for wound rotor induction machines, with all the advantages listed above. However, because in this case the rotor winding is usually a multiphase AC winding, skin-effect again becomes a concern and conductor transposition may be necessary.

While at least one example embodiment has been presented in the foregoing detailed description, it should be appreciated that a vast number of variations exist. It should also be appreciated that the example embodiment or example embodiments are not intended to limit the scope, applicability, or configuration of the invention in any way. Rather, the foregoing detailed description will provide those skilled in the art with a convenient road map for implementing the inventive aspects that may be found in at least one embodiment. The subject matter of the invention includes all combinations and subcombinations of the various elements, features, functions and/or properties disclosed in the example embodiments. It should be further understood that various changes can be made in the function and arrangement of elements without departing from the scope of the invention as defined in the appended claims and the legal equivalents thereof.

What is claimed is:

1. An electrical machine rotor, comprising:
a cylinder having an edge;
a first slot proximate to the edge of the cylinder, the first slot at least partially closed by the edge; and
a hairpin winding disposed within the first slot.

2. The electrical machine rotor of claim 1, wherein the first slot is fully closed.

3. The electrical machine rotor of claim 1, the first slot comprising a first slot opening, a width of the first slot opening less than a width of the first slot.

4. The electrical machine rotor of claim 1, further comprising a second slot proximate to the edge of the cylinder and at least partially closed.

5. The electrical machine rotor of claim 4, the cylinder comprising a plurality of laminations, each of the plurality of laminations having a first opening corresponding to the first slot and a second opening corresponding to the second slot, the plurality of laminations arranged such that the first openings are aligned with one another and the second openings are aligned with one another.

6. The electrical machine rotor of claim 4, wherein the hairpin winding is disposed within the second slot.

7. The electrical machine rotor of claim 6, the hairpin winding comprising:
a first leg disposed within the first slot;
a second leg disposed within the second slot; and
an end turn that joins the first leg to the second leg.

8. The cylindrical rotor of claim 7, wherein the hairpin winding is at least partially formed of copper.

9. A method of fabricating a rotor for an electrical machine, the method comprising the steps of:
fabricating a first slot and a second slot proximate to an edge of a rotor, the first and second slots at least partially closed by the edge of the rotor;
inserting a first end of a first hairpin winding into a first end of the first slot;
inserting a second end of the first hairpin winding into a first end of the second slot, the first end of the first slot and the first end of the second slot disposed at an end of the rotor; and
advancing the first and second ends of the first hairpin winding in a same direction through the first and second slots, respectively, such that the first and second ends of the first hairpin winding exit the first and second slots from a second end of the first slot and a second end of the second slot, the second end of the first slot and the second end of the second slot disposed at another end of the rotor.

10. The method of claim 9, further comprising bending a conductive metal bar to form the first hairpin winding.

11. The method of claim 10, wherein bending the conductive metal bar comprises bending a rectangular copper bar to form the first hairpin winding.

12. The method of claim 9, further comprising:
connecting the first end of the first hairpin winding to an end of a second hairpin winding; and
connecting the second end of the first hairpin winding to an end of a third hairpin winding.

13. The method of claim 12, wherein connecting the first end of the first hairpin winding to the end of the second hairpin winding comprises bending the first end of the first hairpin winding to meet the end of the second hairpin winding.

14. An electrical machine comprising:
a stator;
a stator winding disposed on the stator;
a shaft disposed inside the stator;
a cylindrical rotor attached to the shaft;
a first slot proximate to an edge of the cylindrical rotor, the first slot at least partially closed; and
a hairpin winding disposed within the first slot.

15. The electrical machine of claim 14, wherein the first slot is closed.

16. The electrical machine of claim 14, the first slot disposed such that a cross section of the cylindrical rotor taken in a direction perpendicular to the length of the first slot illustrates that a surface of the cylindrical rotor is continuous with a surface of the first slot.

17. The electrical machine of claim 16, further comprising a second slot proximate to an edge of the cylindrical rotor, the second slot at least partially closed.

18. The electrical machine of claim 17, the cylindrical rotor comprising a plurality of laminations, each of the plurality of laminations having a first opening corresponding to the first slot and a second opening corresponding to the second slot, the plurality of laminations structured to be arranged such that the first openings are aligned with one another and the second openings are aligned with one another.

19. The electrical machine of claim 17, the hairpin winding disposed within the second slot.

20. The electrical machine of claim 19, the hairpin winding comprising:
a first leg disposed within the first slot;
a second leg disposed within the second slot; and
an end turn that attaches the first leg to the second leg, the length of the winding element including a length of the first leg, a length of the second leg, and a length of the end turn.
